(19) United States
(12) Patent Application Publication
(10) Pub. No.: US 2018/0198292 A1
(43) Pub. Date: Jul. 12, 2018

(54) Universal Power Tool Battery Pack And Recharging System

(71) Applicants: John Lee, Riverside, CA (US); Guanxiong Lu, Wuxi (CN)

(72) Inventors: John Lee, Riverside, CA (US); Guanxiong Lu, Wuxi (CN)

(21) Appl. No.: 15/288,943

(22) Filed: Jan. 12, 2017

(51) Int. Cl. H02J 7/00; H01R 31/06; H01M 10/0525; H01M 2/10

(52) U.S. Cl. CPC H02J 7/0021; H01R 31/06; H01M 2220/30; H01M 2/1055; H01M 10/0525

(57) ABSTRACT

A universal power tool battery pack and recharging system that is selectively connectable to and supportable by a cordless power tool. A battery pack comprises rechargeable lithium-ion battery cells to recharge a power tool battery. A housing forms a protective shell for the battery pack. A connector interfaces with different types, sizes, and models of hand held power tools through the same battery platform. The connector alternatively receives the battery pack and different power tools having different cross-sectional areas through a charging and discharging interface. A connector cover protects the connector and a connector printed circuit board. The system has an automatic cooling system, including a fan, a battery printed circuit board, and vents, for dissipating heat from the battery pack. A dual sequential charger energizes the battery pack. A power display, including a lamp, indicate when the battery pack, or the power tool, or both are fully charged.

### FIELD OF THE INVENTION

The present invention relates generally to a universal power tool battery pack and recharging system. More so, the present invention relates to a system that leverages a battery pack, a dual sequential charger, and a connector to selectively connect and support different types and models of cordless power tools; whereby the connector simultaneously interfaces with different types of hand held power tools through the same battery platform; whereby the battery pack comprises a plurality of rechargeable lithium-ion battery cells located within a protective housing; whereby the housing forms a protective shell for the battery cells; whereby the battery pack has an automatic cooling system, including a fan, a battery printed circuit board, and vents, for dissipating heat from the battery cells; and whereby the dual sequential charger recharges multiple battery packs simultaneously.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, power tools, and in particular hand held power tools, increasingly depend on cordless rechargeable battery packs as a powering energy source. Such battery packs are preferably compact and lightweight, but must still deliver relatively high current and voltage for powering the tool motor.

A battery pack is a set of any number of identical batteries or individual battery cells. They may be configured in a series, parallel or a mixture of both to deliver the desired voltage, capacity, or power density. Components of battery packs include the individual batteries or cells, and the multiple interconnects which provide electrical conductivity between the batteries. Rechargeable battery packs often contain a temperature sensor, which the battery charger uses to detect the end of charging. Interconnects are also found in batteries as they are the part which connects each cell, though batteries are most often only arranged in series strings.

It is desirable to rapidly and efficiently charge power tool battery packs due to the increased demands placed by users on their power tools. As more users use different cordless power tools on the jobsite, the demand for charged batteries throughout the day has increased. However, there are myriad power tools of different sizes, manufacturers, and functions. Often, these power tools do not have the same mating capacity with the same rechargeable battery packs and connectors.

It is known that lithium-ion (Li-ion) batteries have begun replacing nickel-cadmium (NiCd), nickel-metal-hydride (NiMH), and lead-acid batteries in low-voltage, portable electronic devices such as cordless power tools. Unfortunately, Li-ion batteries may rapidly deteriorate when subjected to overcharging, over-discharging, overheating, or over-cooling conditions.

Other proposals have involved recharging assemblies for cordless power tools. The problem with these is that they are not always adaptable to the different types, sizes, and manufacturers of power tools. Also, the battery packs heat up excessively, causing other problems for the recharging system. Even though the above cited recharging assemblies for cordless power tools meet some of the needs of the market, a universal power tool battery pack and recharging system. The system leverages a battery pack to recharge a tool battery, a dual sequential charger to energize the battery pack, a connector to selectively connect and support different types and models of cordless power tools, and a battery pack cooling system to dissipate heat from the battery pack is still desired.

### SUMMARY

Illustrative embodiments of the disclosure are generally directed to a universal power tool battery pack and recharging system. The system leverages a battery pack to recharge a tool battery, a dual sequential charger to energize the battery pack, and a connector to selectively connect and support different types and models of cordless power tools. The system provides a connector having different cross-sectional areas for simultaneously interfacing with different types of hand held power tools through the same battery platform. The connector is operable with numerous power tool designs, models, and power tool connective mechanisms known in the art.

The connector may include a charging and discharging interface that is adapted to couple with different types of power tools and battery packs simultaneously. The connector may also have a plurality of tool docking ports to couple to the power tool. Additionally, the connector couples with a plurality of battery packs. The connector completes an electrical circuit between the plurality of battery packs and the plurality of power tools.

The connector may also have a battery docking port to connect to the battery pack. A first button and a second button may be used to lock and unlock the connector from the battery pack. A power display and a lamp that illuminates work to indicate when the battery packs, or the power tool, or both are fully charged. A connector cover may be used to protect the connector.

The system may utilize a battery pack to recharge the battery in the power tool. The battery pack may include a set of any number of identical batteries or individual battery cells. They may be configured in a series, parallel or a mixture of both to deliver the desired voltage, capacity, or power density. In one embodiment, the battery cells are a plurality of rechargeable lithium-ion battery cells located within a protective housing. The battery cells may be arranged in series.

The system utilizes a housing that forms a protective shell for the battery pack. Further, the system has an automatic cooling system for dissipating heat from the battery pack. The automatic cooling system may include a fan and a series of vents that dissipate heat from the battery pack. A battery pack printed circuit board (PCB) detects when heat has reached a predetermined temperature and actuates the fan.

The system has a dual sequential charger for recharging multiple battery packs simultaneously. The dual sequential charger may include a charger dock to receive the battery packs. The dual sequential charger charges the battery packs upon secure attachment therebetween. A display and light indicates when the battery pack is fully charged.

In one aspect, a universal power tool battery pack and recharging system, comprises:
a battery pack comprising an insertion portion;
a housing configured to at least partially encapsulate the battery pack, the housing comprising a plurality of vents;
a fan disposed proximal to the battery pack;
a battery printed circuit board configured to process the detection of a predetermined temperature proximal to the battery pack, the battery printed circuit board further configured to actuate the fan upon reaching the predetermined temperature;
a dual sequential charger configured to mate with the insertion portion of the battery pack, the dual sequential charger further configured to energize the battery pack;
a power display configured to indicate when the battery packs is fully charged by the dual sequential charger; and
a connector configured to alternatively receive the battery pack and a plurality of power tools having different cross-sectional areas through a charging and discharging interface, the charging and discharging interface having a sidewall and an opening formed in a housing wall and circumscribing a tool docking area corresponding approximately to the transverse cross-sectional area of the plurality of power tools, the charging and discharging interface further configured to complete an electrical circuit between the battery pack and the plurality of power tools.

In another aspect, the battery pack comprises rechargeable lithium-ion battery cells.

In another aspect, the battery pack comprises a plurality of battery cells arranged in series.

In another aspect, the housing is bifurcated and configured to close around the plurality of battery packs.

In another aspect, the fan is a direct current mini fan.

In another aspect, the vents are disposed in a spaced-apart relationship through the housing.

In another aspect, the system further comprises a connector printed circuit board configured to process connectivity by the charging and discharging interface.

In another aspect, the system further comprises a connector cover configured to at least partially encapsulate the connector and the connector printed circuit board.

In another aspect, further including a lamp.

In another aspect, the lamp is operable with the display to indicate when the plurality of battery packs are fully charged by the dual sequential charger.

In another aspect, the system further comprises a first button and a second button operatively connected to the connector, the first button and the second button configured to lock and unlock the connector from the battery pack.

In another aspect, the first button and the second button comprise a button light configured to indicate operation of the buttons.

In another aspect, the system further comprises a power printed circuit board configured to enable powering of the dual sequential charger.

In another aspect, the system further comprises a power display cover plate configured to at least partially cover the power display.

In another aspect, the system further comprises an internal battery cover disposed beneath the housing.

In another aspect, the fan comprises a fan cover.

One objective of the present invention is to increase compatibility and convenience of batteries and chargers while maintaining a reasonable cost.

Another objective is to interface with multiple power tools from different companies and model types with the same battery platform.

Another objective is to increase battery use life.

Another objective is to dissipate excess heat from the battery pack.

Yet another objective is to charge multiple power tools simultaneously.

Yet another objective is to provide an 18 volt dual sequential charger that can charge the battery pack.

Yet another objective is to provide a protective housing to protect the battery pack.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary universal power tool battery pack and recharging system, in accordance with an embodiment of the present invention;

FIGS. 2A, 2B, 2C, 2D, and 2E illustrate various views of a dual sequential charger, where FIG. 2A is a left side view, FIG. 2B is a front end view, FIG. 2C is a top view, FIG. 2D is a rear end view, and FIG. 2E is a right side view, in accordance with an embodiment of the present invention;

FIGS. 3A, 3B, 3C, 3D, and 3E illustrate various views of a small battery pack, where FIG. 3A is a front end view, FIG. 3B is a top view, FIG. 3C is a left side view, FIG. 3D is a bottom view, and FIG. 3E is a rear end view, in accordance with an embodiment of the present invention;

FIGS. 4A, 4B, 4C, 4D, and 4E illustrate various views of a large battery pack, where FIG. 4A is a front end view, FIG. 4B is a top view, FIG. 4C is a left side view, FIG. 4D is a bottom view, and FIG. 4E is a rear end view, in accordance with an embodiment of the present invention;

FIGS. 5A, 5B, 5C, 5D, and 5E illustrate various views of a connector adapted for a BOSCH power tool, where FIG. 5A is a front end view, FIG. 5B is a top view, FIG. 5C is a left side view, FIG. 5D is a bottom view, and FIG. 5E is a rear end view, in accordance with an embodiment of the present invention;

FIGS. 6A, 6B, 6C, 6D, 6E, and 6F illustrate various views of connector adapted for a DEWALT power tool, where FIG. 6A is a top view, FIG. 6B is a left side view, FIG. 6C is a bottom view, FIG. 6D is a rear end view, FIG. 6E is a front end view, and FIG. 6F is a right side view, in accordance with an embodiment of the present invention; and

FIGS. 7A, 7B, 7C, 7D, and 7E illustrate various views of connector adapted for a MILWAUKEE power tool, where FIG. 7A is a top view, FIG. 7B is a left side view, FIG. 7C is a bottom view, FIG. 7D is a rear end view, and FIG. 7E is a front end view, in accordance with an embodiment of the present invention.

Like reference numerals refer to like parts throughout the various views of the drawings.

### DETAILED DESCRIPTION OF THE INVENTION

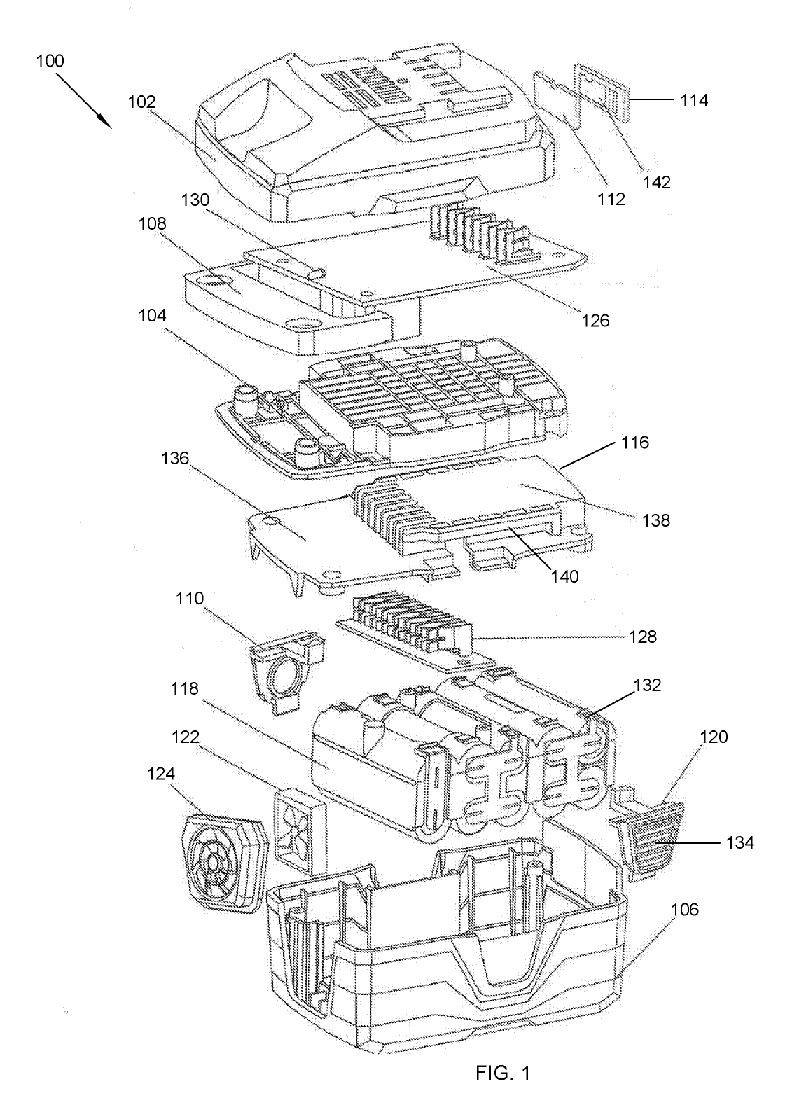

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

A universal power tool battery pack and recharging system 100 is referenced in FIGS. 1, 2A, 2B, 2C, 2D, 2E, 3A, 3B, 3C, 3D, 3E, 4A, 4B, 4C, 4D, 4E, 5A, 5B, 5C, 5D, 5E, 6A, 6B, 6C, 6D, 6E, 6F, 7A, 7B, 7C, 7D, and 7E. The universal power tool battery pack and recharging system 100, hereafter “system 100” provides a battery pack 118 to recharge a power tool battery, a dual sequential charger 200 to energize the battery pack 118, and a connector 104 to selectively connect and support different types, sizes, manufacturing models of cordless power tools. The system also provides a unique cooling system to maintain the battery pack 118 at or below a predetermined temperature.

In one embodiment, the system 100 provides a battery pack 118 for recharging the power tool battery. The battery pack 118 may include rechargeable lithium-ion battery cells. A housing 106 forms a protective shell for the battery pack 118. The system 100 has an automatic cooling system 100, including a fan 122, a battery printed circuit board 128, and a plurality of vents 134 on the housing 106, for dissipating heat from the battery pack 118.

A connector 104 simultaneously interfaces with multiple power tools that may have different types, sizes, and manufacturing models. The same battery platform is used to interface and charge all the power tools. The connector 104 comprises a charging and discharging interface 116 to engage the power tools and battery pack 118, a connector printed circuit board 126 to process the charging and discharging interface 116, and a connector cover 102 to protect the connector 104 and the connector printed circuit board 126.

The system 100 may also include a dual sequential charger for energizing the battery pack 118. A power display 142 and a lamp 108 work together to indicate when the battery pack 118, or the power tools, or both are fully charged.

In one embodiment, the system 100 serves to selectively recharge and support a variety of different styles and models of cordless power tools. The system 100 provides a connector 104 having different cross-sectional areas for simultaneously interfacing with different types of hand held power tools through the same battery platform. The connector 104 is operable with numerous sizes, types, and designs of power tool known in the art, including, without limitation, a BOSCH power tool, a DEWALT power tool, and a MILWAUKEE power tool. In some embodiments, the system 100 may provide different connectors 50, 600, 700 that adapt to the different manufacturers, as shown below. In an alternative embodiment, the connector 104 is also operable with a MAKITA power tool and a METABO power tool.

In one exemplary power tool design, the power tool may have a drill or driver having a tool housing and a pistol type handle. A motor may be located within the tool housing for driving a tool output. A tool battery may be connectable to a supported by the tool handle. A tool controller such as a trigger is located adjacent the junction between the tool housing and the tool handle for coupling energy from the tool battery to the motor. The system 100 works to interface with, and thereby recharge a wide variety of such power tools while maintaining battery packs at a constant, low temperature.

As referenced in FIG. 1, the system 100 comprises a battery pack 118 having an insertion portion 132 for docking during recharging/energizing operations. The battery pack 118 is configured to recharge the tool battery in the power tool. In some embodiments, the battery pack 118 may include a set of any number of identical batteries or individual battery cells. They may be configured in a series, parallel or a mixture of both to deliver the desired voltage, capacity, or power density. In one embodiment, the battery pack 118 comprises ten rechargeable lithium-ion battery cells. The battery cells may be arranged in series or in parallel.

The insertion portion 132 of the battery pack 118 provides a conductive mating surface with the dual sequential charger 200. The insertion portion 132 may include battery terminal block comprising a positive battery contact located and configured to make electrical contact with a positive receptacle contact, and a negative battery contact located and configured to make contact with the negative receptacle contact.

In some embodiments, a housing 106 protectively encapsulates the battery pack 118. The housing 106 may have a bifurcated design that encapsulates the battery pack 118 with two pieces. Though in other embodiments, the housing 106 is a unitary piece of molded plastic. The housing 106 is configured to maintain the battery packs at a safe, cool temperature beneath a predetermined temperature. The housing 106 may have a plurality of vents 134 that are disposed in a spaced-apart relationship through the sidewalls of the housing 106. In one embodiment, an internal battery cover 120 is disposed beneath the housing 106 to provide secondary protection.

In some embodiments, a fan 122 is disposed proximal to the battery pack 118. The fan 122 may include a direct current fan that blows cool air onto the battery pack 118 to dissipate heat generated by the battery pack 118 through the vents 134 in the housing 106. The fan may be fabricated from yttrium metal. A fan cover 124 may be used to protect the blades of the fan 122 from damage.

The cooling mechanism of the system 100 further comprises a battery printed circuit board 128 that processes the detection of a predetermined temperature proximal to the battery pack 118. The battery printed circuit board 128 enables the fan to be actuated upon reaching the predetermined temperature. In one embodiment, the battery printed circuit board 128 is operable with a thermostat and a trigger switch to perform this fan actuation function.

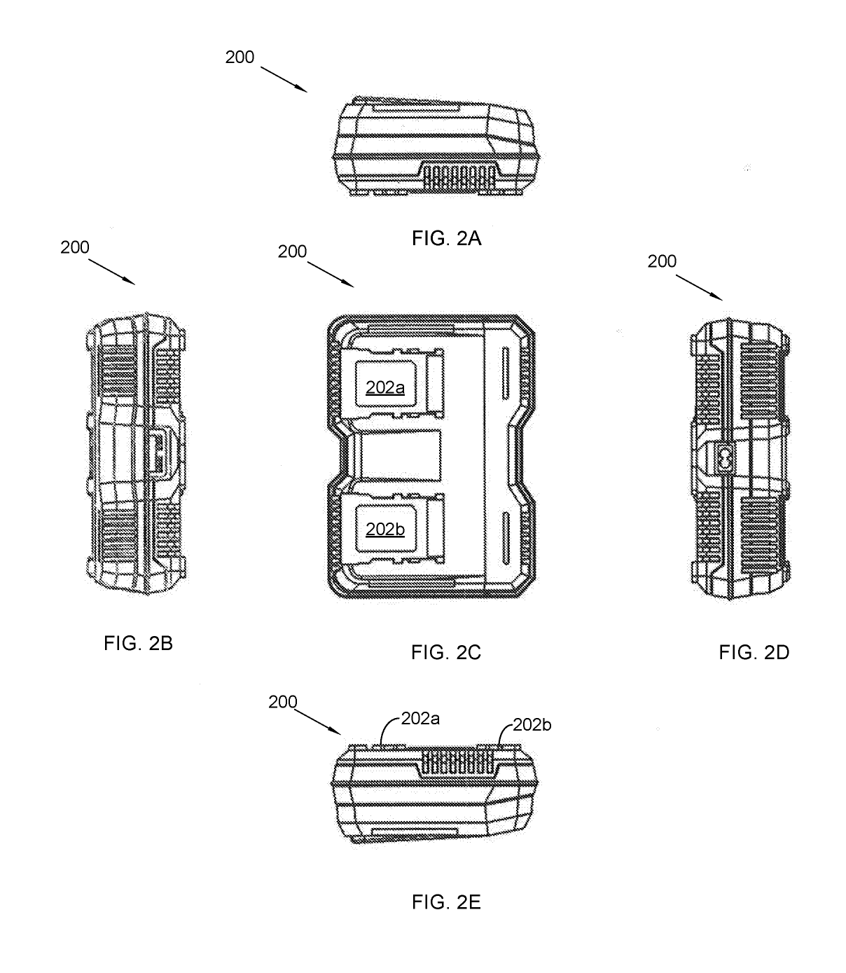

Looking now at FIG. 2A, the system 100 has a dual sequential charger 200 for energizing the battery pack 118. The dual sequential charger 200 may include a charger dock to mate with the insertion portion 132 of the battery pack 118. The dual sequential charger 200 energizes the battery pack 118 upon secure attachment therebetween. A power printed circuit board 112, shown in FIG. 1, is configured to regulate powering on and off of the dual sequential charger 200.

In some embodiments, a power display 142 and a lamp 108 indicates when the battery pack is fully charged, and the battery pack 118 power consumption. A power display cover plate 114 at least partially covers the power display. The cover plate 114 may be transparent and fabricated from a durable plastic. The power display 142 indicates when the plurality of battery packs 118 are fully charged by the dual sequential charger. The lamp 108 may also illuminate when the charge is completed or when the temperature of the battery pack 118 reaches the predetermined temperature. In this manner, the lamp 108 is also operatively connected to the battery PCB. The power display 142 may include a digital number from 0-100%. A color code may also be used by the power display 142.

The system 100 uses a unique a connector 104 for simultaneously interfacing with different types of hand held power tools through the same battery platform. The connector 104 is generally adapted to 18 volt power tools and lithium-ion battery packs. The connector 104 alternatively receives the battery packs and the power tools, which have different cross-sectional areas, through a charging and discharging interface 116. The charging and discharging interface 116 completes an electrical circuit between the battery packs 108 and the power tools.

The charging and discharging interface 116 comprises a sidewall 140 and an opening formed in a housing wall and circumscribing a battery docking area 136 corresponding approximately to the transverse cross-sectional area of the battery packs. The charging and discharging interface further comprises a second sidewall and a second opening formed in a second housing wall and circumscribing a tool docking area 138 corresponding approximately to the transverse cross-sectional area of the power tools. A connector printed circuit board 126 is configured to process connectivity by the charging and discharging interface 116.

The system 100 may further include a connector printed circuit board 126 that processes the connections and electrical charges through the charging and discharging interface 116. A connector cover 102 configured to at least partially encapsulate the connector 104 and the connector printed circuit board 126. The system 100 further comprises at least one button 110 operatively connected to the connector 104, the at least one button 110 is configured to lock and unlock the connector from the battery pack 118. In one embodiment, the at least one button 110 comprises an A6 button and a B11 button. The button 110 comprise a button light 130 configured to indicate operation of the buttons 110.

Turning now to FIGS. 2A, 2B, 2C, 2D, and 2E, a dual sequential charger 200 for energizing the battery pack 118 is illustrated in multiple views. FIG. 2A is a left side view, FIG. 2B is a front end view, FIG. 2C is a top view, FIG. 2D is a rear end view, and FIG. 2E is a right side view. The dual sequential charger 200 may include at least one charger dock 202a, 202b to mate with the insertion portion 132 of the battery pack 118. The dual sequential charger 200 energizes the battery pack 118 upon secure attachment therebetween. A power printed circuit board 112, shown in FIG. 1, is configured to regulate powering on and off of the dual sequential charger 200. In one embodiment, the dual sequential charger 200 is a 3×18 volt, 4.0 Ah or 5.0 Ah.

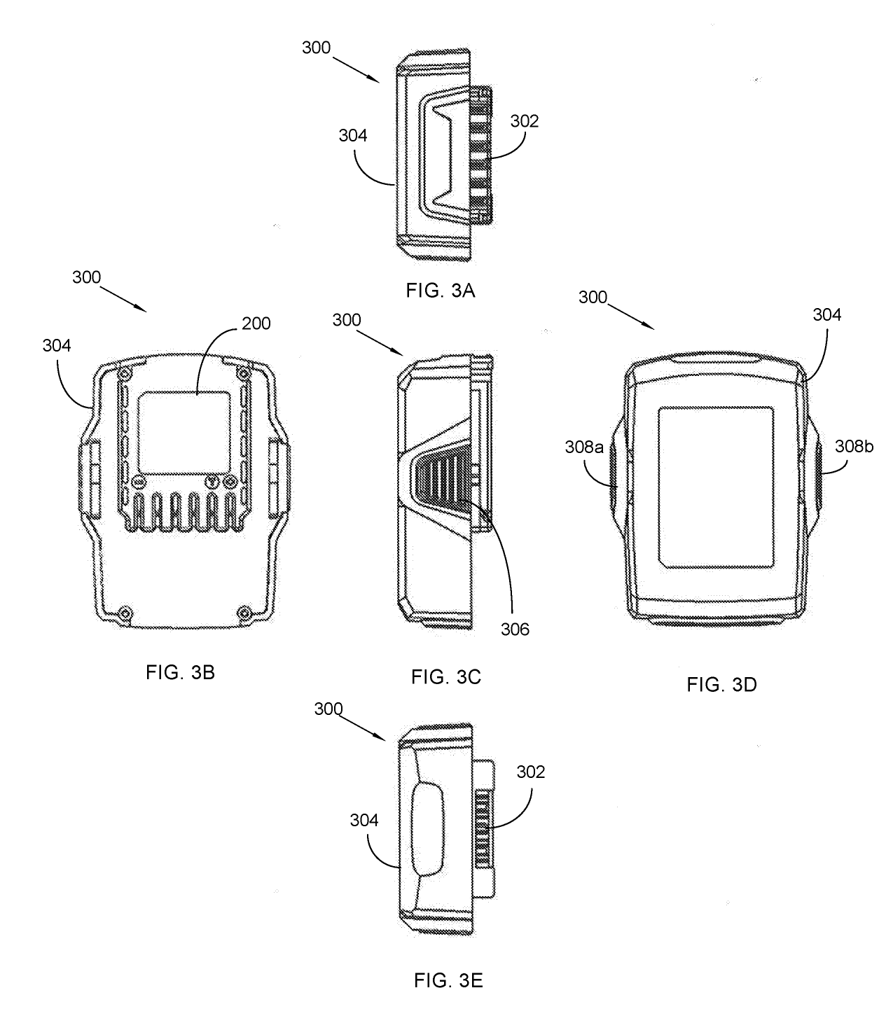

FIGS. 3A, 3B, 3C, 3D, and 3E illustrate a small battery pack 300. The small battery pack may have less than ten battery cells 302, and the housing 304 may be shorter. The housing 304 also has the plurality of vents 306, and two fans 308a, 308b on each side of the housing 304, as described above. This can be advantageous for generating minimal heat; and especially for smaller power tools. In the small battery pack illustrations shown, FIG. 3A is a front end view, FIG. 3B is a top view, FIG. 3C is a left side view, FIG. 3D is a bottom view, and FIG. 3E is a rear end view.

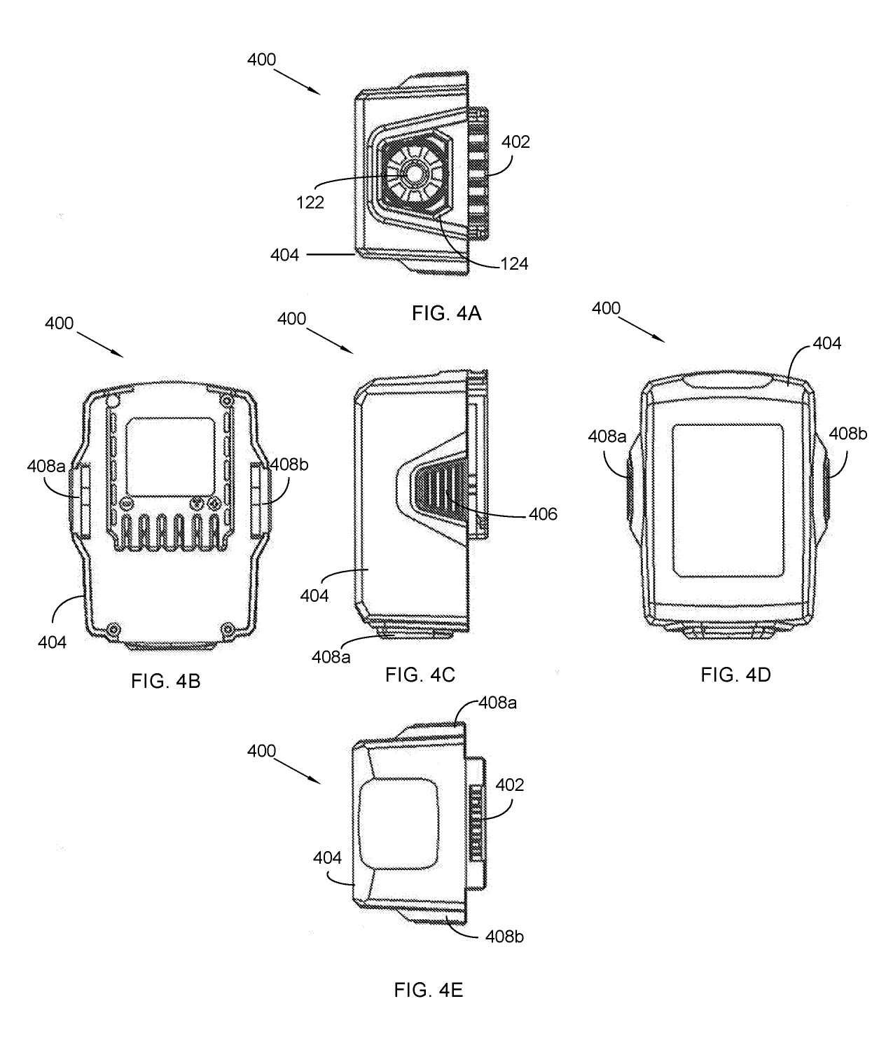

FIGS. 4A, 4B, 4C, 4D, and 4E illustrate a large battery pack 400, where ten or more battery cells 402 may be used. Here, the housing 404 that protects the battery pack 400 is generally taller and wider. Additional vents 406 and a pair of fans 408a, 408b may be integrated into the larger housing 404. This can be advantageous for larger power tools. FIG. 4A is a front end view of a large battery pack, FIG. 4B is a top view, FIG. 4C is a left side view, FIG. 4D is a bottom view, and FIG. 4E is a rear end view.

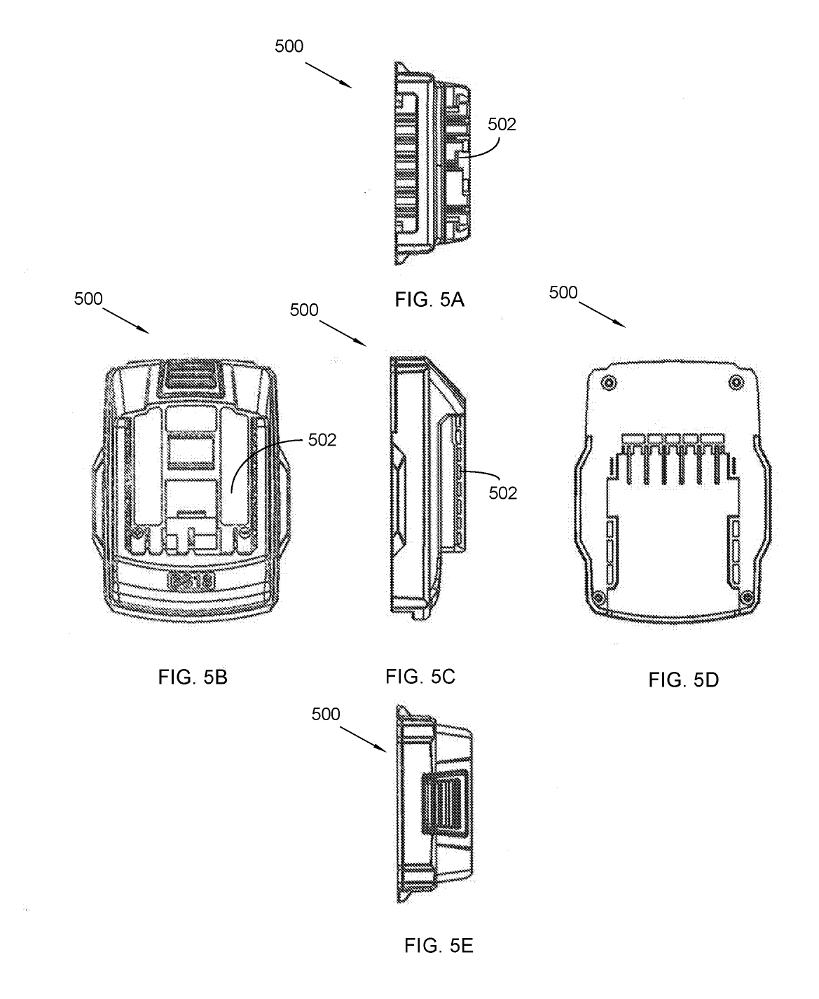

FIGS. 5A, 5B, 5C, 5D, and 5E illustrate a connector 500 adapted for a BOSCH power tool, where FIG. 5A is a front end view, FIG. 5B is a top view, FIG. 5C is a left side view, FIG. 5D is a bottom view, and FIG. 5E is a rear end view. Similar to connector 104 described above, the BOSCH connector 500 interfaces with different types of BOSCH power tools through the same battery platform. The connector 500 may be adapted to 18 volt BOSCH power tools and lithium-ion battery packs. The connector 500 alternatively receives the battery packs and the power tools, which have different cross-sectional areas, through a charging and discharging interface 502.

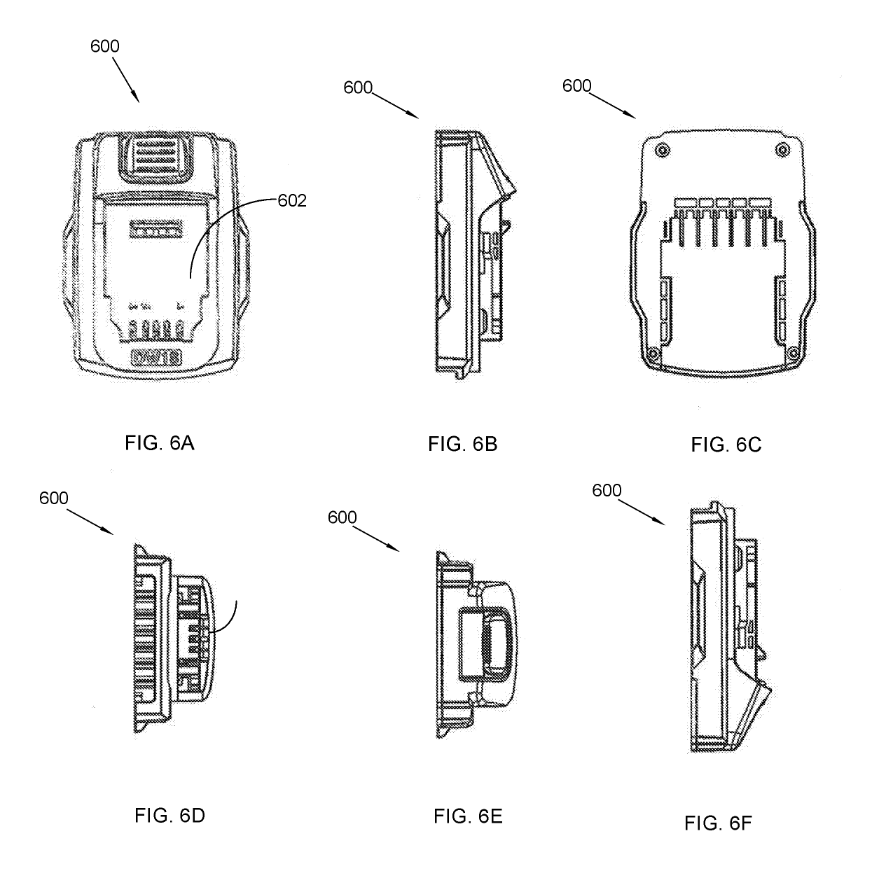

FIGS. 6A, 6B, 6C, 6D, 6E, and 6F illustrate connector 600 adapted for a DEWALT power tool, where FIG. 6A is a top view, FIG. 6B is a left side view, FIG. 6C is a bottom view, FIG. 6D is a rear end view, FIG. 6E is a front end view, and FIG. 6F is a right side view. Similar to connector 104 described above, the DEWALT connector 600 interfaces with different types of DEWALT power tools through the same battery platform. The connector 600 may be adapted to 18 volt DEWALT power tools and lithium-ion battery packs. The connector 600 alternatively receives the battery packs and the power tools, which have different cross-sectional areas, through a charging and discharging interface 602.

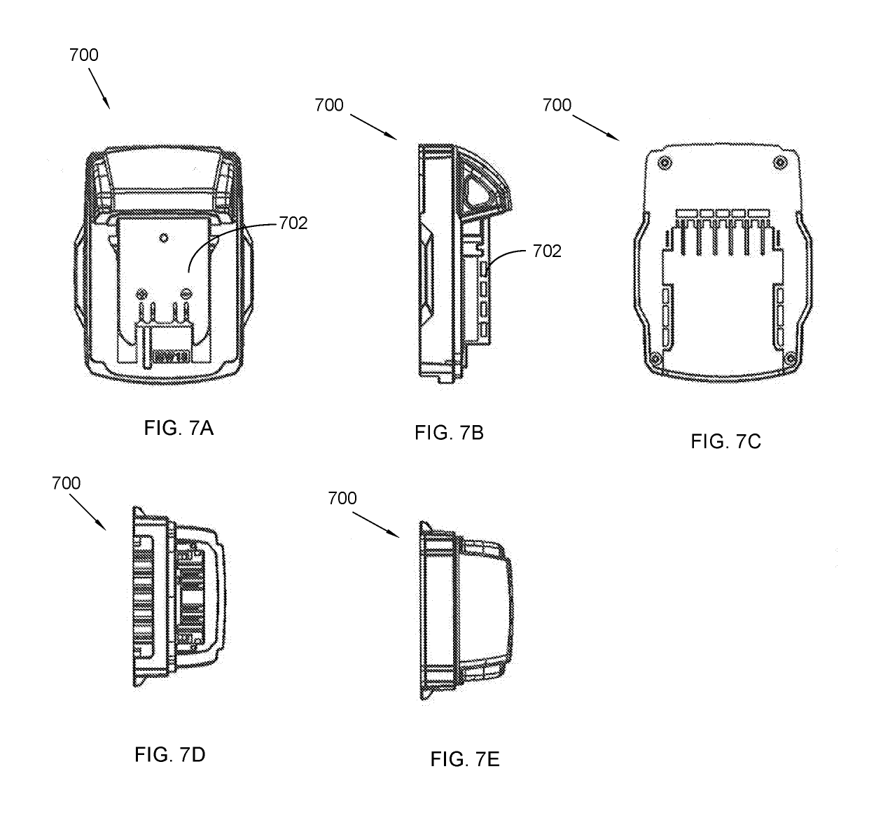

FIGS. 7A, 7B, 7C, 7D, and 7E illustrate connector 700 adapted for a MILWAUKEE power tool, where FIG. 7A is a top view, FIG. 7B is a left side view, FIG. 7C is a bottom view, FIG. 7D is a rear end view, and FIG. 7E is a front end view. Similar to connector 104 described above, the MILWAUKEE connector 700 interfaces with different types of MILWAUKEE power tools through the same battery platform. The connector 700 may be adapted to 18 volt MILWAUKEE power tools and lithium-ion battery packs. The connector 700 alternatively receives the battery packs and the power tools, which have different cross-sectional areas, through a charging and discharging interface 702.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A universal power tool battery pack and recharging system, the system comprising:
a battery pack comprising an insertion portion;
a housing configured to at least partially encapsulate the battery pack, the housing comprising a plurality of vents;
a fan disposed proximal to the battery pack;
a battery printed circuit board configured to process the detection of a predetermined temperature proximal to the battery pack, the battery printed circuit board further configured to actuate the fan upon reaching the predetermined temperature;
a dual sequential charger configured to mate with the insertion portion of the battery pack, the dual sequential charger further configured to energize the battery pack;
a power display configured to indicate when the battery pack is fully charged by the dual sequential charger; and
a connector configured to alternatively receive the battery pack and a plurality of power tools having different cross-sectional areas through a charging and discharging interface, the charging and discharging interface having a sidewall and an opening formed in a housing wall and circumscribing a tool docking area corresponding approximately to the transverse cross-sectional area of the plurality of power tools, the charging and discharging interface further configured to complete an electrical circuit between the battery pack and the plurality of power tools.

2. The system of claim 1, wherein the battery pack comprises rechargeable lithium-ion battery cells.

3. The system of claim 1, wherein the battery pack comprises a plurality of battery cells arranged in series.

4. The system of claim 1, wherein the housing is bifurcated and configured to close around the battery pack.

5. The system of claim 1, wherein the fan is a direct current mini fan.

6. The system of claim 1, wherein the plurality of vents are disposed in a spaced-apart relationship through the housing.

7. The system of claim 1, further comprising a connector printed circuit board configured to process connectivity by the charging and discharging interface.

8. The system of claim 7, further comprising a connector cover configured to at least partially encapsulate the connector and the connector printed circuit board.

9. The system of claim 1, further comprising a lamp, the lamp operable with the power display to indicate when the battery pack is fully energized by the dual sequential charger.

10. The system of claim 1, further comprising at least one button operatively connected to the connector, the at least one button configured to lock and unlock the connector from the battery pack.

11. The system of claim 10, wherein the at least one button comprises a button light configured to indicate operation of the at least one button.

12. The system of claim 1, further comprising a power printed circuit board configured to regulate powering on and off of the dual sequential charger.

13. The system of claim 1, wherein the dual sequential charger comprises at least one charger dock configured to mate with the insertion portion of the battery pack.

14. The system of claim 1, further comprising a power display cover plate configured to at least partially cover the power display.

15. The system of claim 1, further comprising an internal battery cover disposed beneath the housing.

16. A universal power tool battery pack and recharging system, the system comprising:
a battery pack comprising an insertion portion;
a housing configured to at least partially encapsulate the battery pack, the housing comprising a plurality of vents;
an internal battery cover disposed beneath the housing;
a fan disposed proximal to the battery pack;
a battery printed circuit board configured to process the detection of a predetermined temperature proximal to the battery pack, the battery printed circuit board further configured to actuate the fan upon reaching the predetermined temperature;
a dual sequential charger comprising at least one charger dock configured to mate with the insertion portion of the battery pack, the dual sequential charger further configured to energize the battery pack;
a power printed circuit board configured to regulate powering on and off of the dual sequential charger;
a power display configured to indicate when the battery pack is fully charged by the dual sequential charger;
a power display cover plate configured to at least partially cover the power display;
a connector configured to alternatively receive the battery pack, the connector having different cross-sectional areas through a charging and discharging interface, the charging and discharging interface having a sidewall and an opening formed in a housing wall and circumscribing a tool docking area;
a lamp, the lamp operable with the power display to indicate when the battery pack is fully energized by the dual sequential charger; and
at least one button operatively connected to the connector, the at least one button configured to lock and unlock the connector from the battery pack, the at least one button comprising a button light configured to indicate operation of the at least one button.

17. The system of claim 16, wherein the tool docking area corresponds approximately to the transverse cross-sectional area of a plurality of power tools, the charging and discharging interface further configured to complete an electrical circuit between the battery pack and the plurality of power tools.

18. The system of claim 17, further comprising a connector printed circuit board configured to process connectivity by the charging and discharging interface.

19. The system of claim 18, wherein the connector is adapted to at least one of the following manufacturers of the plurality of power tools: a BOSCH power tool, a DEWALT power tool, a MILWAUKEE power tool, a MAKITA power tool, and a METABO power tool.

20. A universal power tool battery pack and recharging system, the system comprising:
a battery pack comprising an insertion portion;
a housing configured to at least partially encapsulate the battery pack, the housing comprising a plurality of vents;
an internal battery cover disposed beneath the housing;
a fan disposed proximal to the battery pack;
a battery printed circuit board configured to process the detection of a predetermined temperature proximal to the battery pack, the battery printed circuit board further configured to actuate the fan upon reaching the predetermined temperature;
a dual sequential charger comprising at least one charger dock configured to mate with the insertion portion of the battery pack, the dual sequential charger further configured to energize the battery pack;
a power printed circuit board configured to regulate powering on and off of the dual sequential charger;
a power display configured to indicate when the battery pack is fully charged by the dual sequential charger;
a power display cover plate configured to at least partially cover the power display;
a connector configured to alternatively receive the battery pack and a plurality of power tools having different cross-sectional areas through a charging and discharging interface, the charging and discharging interface having a sidewall and an opening formed in a housing wall and circumscribing a tool docking area corresponding approximately to the transverse cross-sectional area of the plurality of power tools, the charging and discharging interface further configured to complete an electrical circuit between the battery pack and the plurality of power tools;
a lamp, the lamp operable with the power display to indicate when the battery pack is fully energized by the dual sequential charger; and
at least one button operatively connected to the connector, the at least one button configured to lock and unlock the connector from the battery pack, the at least one button comprising a button light configured to indicate operation of the at least one button.
